(19) United States
(12) Patent Application Publication
(10) Pub. No.: US 2017/0205277 A1
(43) Pub. Date: Jul. 20, 2017

(54) UNEVEN BRIGHTNESS MEASURING APPARATUS

(71) Applicant: Mitsubishi Electric Corporation, Tokyo (JP)

(72) Inventor: Hideyo OHTSUKI, Tokyo (JP)

(73) Assignee: Mitsubishi Electric Corporation, Tokyo (JP)

(21) Appl. No.: 15/397,796

(22) Filed: Jan. 4, 2017

(30) Foreign Application Priority Data
Jan. 19, 2016 (JP) 2016-007616

(51) Int. Cl. G01J 1/02; G01J 1/44

(52) U.S. Cl. CPC G01J 1/0266; G01J 1/44; G01J 2001/4247

(57) ABSTRACT

An uneven brightness measuring apparatus of the present invention includes a brightness measuring device, a jig, and a measurement data combiner. The brightness measuring device measures an in-plane brightness of a display surface of a measurement sample. The brightness measuring device is mounted on the jig. The jig includes a rotation mechanism to rotate the brightness measuring device about a nodal point of the brightness measuring device. The measurement data combiner combines first measurement data of a first display area in the display area and second measurement data of a second display area in the display area adjacent to the first display area. These pieces of data are obtained by the brightness measuring device. The second measurement data is obtained through measurement of the second display area by the brightness measuring device rotated in a position different from that in the measurement of the first display area.

### BACKGROUND OF THE INVENTION

Field of the invention

The present invention relates to an uneven brightness measuring apparatus that measures the brightness distribution in a display area of a display.

Description of the Background Art

Displays such as liquid crystal displays find applications in various technical fields including notebook computers, televisions, and mobile phones. For improvement in display quality, the distribution (unevenness) in the lightness (brightness) or color (chromaticity) in a display surface is an issue, leading to demands for apparatuses that measure uneven brightness or uneven chromaticity with high definition.

Measurement equipment manufacturers have developed measurement apparatuses as the measurement apparatuses for quantitatively evaluating uneven brightness or uneven chromaticity. For example, the 2D color analyzer for luminance measurement (CA-2000 front Konica Minolta. Inc., see Japanese Patent Application Laid-Open No. 2009-156789) is capable of collectively measuring in-plane brightness distribution as in photographing. This measurement apparatus obtains a resolution of 980×980 dots as a measurement result and can collectively obtain 980×980 pieces of brightness data in one measurement.

Displays such as high definition televisions have recently been required to have higher definition, and correspondingly, the number of pixels in a display area of such a display is on the rise. However, the resolution of the measurement apparatus of Japanese Patent Application Laid-Open No. 2009-156789 is restricted to the resolution of an imaging element. In measuring a sample with a resolution higher than that of the imaging element, thus, the measurement apparatus may yield a relatively rough measurement result.

### SUMMARY OF THE INVENTION

The present invention has an object to provide an uneven brightness measuring apparatus capable of measuring a high-resolution sample with high definition.

A first uneven brightness measuring apparatus according to the present invention includes a brightness measuring device, a jig, and a data combiner. The brightness measuring device measures an in-plane brightness of a display surface of a measurement sample. The brightness measuring device is mounted on the jig. The jig includes a rotation mechanism to rotate the brightness measuring device about a nodal point of the brightness measuring device. The data combiner combines first measurement data of a first display area in the display surface and second measurement data of a second display area in the display surface adjacent to the first display area. The first measurement data and the second measurement data are pieces of data obtained by the brightness measuring device. The first measurement data and the second measurement data are pieces of data obtained through measurements by the brightness measuring device rotated in different positions by the rotation mechanism.

In the first uneven brightness measuring apparatus of the present invention, the brightness measuring device rotates about the nodal point and measures the first display area and the second display area, thus providing continuity to the obtained first measurement data and second measurement data. Combining these pieces of data thus enables measurement of the brightness distribution of a high-resolution measurement sample with high definition.

A second uneven brightness measuring apparatus according to the present invention includes a brightness measuring device and a data combiner. The brightness measuring device measures an in-plane brightness of a display surface of a measurement sample. The data combiner combines first measurement data of a first display area in the display surface and second measurement data of a second display area in the display surface adjacent to the first display area. The first measurement data and the second measurement data are obtained by the brightness measuring device. The brightness measuring device includes a rotation mechanism to rotate the brightness measuring device about a nodal point of the brightness measuring device. The first measurement data and the second measurement data arc pieces of data obtained through measurements by the brightness measuring device rotated in different positions by the rotation mechanism,

In the second uneven brightness measuring apparatus of the present invention, the brightness measuring device rotates about the nodal point and measures the first display area and the second display area, thus providing continuity to the obtained first measurement data and second measurement data. Combining these pieces of data thus enables measurement of the brightness distribution of a high-resolution measurement sample with high definition.

These and other objects, features, aspects and advantages of the present invention will become more apparent from the following detailed description of the present invention when taken in conjunction with the accompanying drawings,

### BRIEF DESCRIPTION OF THE DRAWINGS

FIG. 1 illustrates an outline of uneven brightness measurement according to a first underlying technique;

FIG. 2 illustrates an outline of uneven brightness measurement according to a second underlying technique;

FIG. 3 is a view for explaining a configuration of an uneven brightness measuring apparatus according to a first preferred embodiment and a positional relationship between the uneven brightness measuring apparatus and a measurement sample;

FIG. 4 illustrates a hardware configuration of a computing unit;

FIG. 5 is a flowchart illustrating a procedure of measuring the in-plane brightness of a measurement sample with the uneven brightness measuring apparatus according to the first preferred embodiment;

FIG, 6 is a perspective view for explaining a method for aligning a nodal point of a brightness measuring device;

FIGS. 7A, 7B, and 7C are top views for explaining the method for aligning the nodal point of the brightness measuring device;

FIGS. 8A, 8B, and 8C are views for explaining a measurement method by the uneven brightness measuring apparatus according to the first preferred embodiment;

FIG. 9 illustrates a brightness measurement result before correction of a first display area;

FIG. 10 illustrates an image for finding a boundary of a display area;

FIG. 11 illustrates a positional relationship between a display area and the brightness measuring device in brightness measurement; and

FIG. 12 illustrates a configuration of an uneven brightness measuring apparatus according to a second preferred embodiment.

### DESCRIPTION OF THE PREFERRED EMBODIMENTS

### A. Underlying Techniques

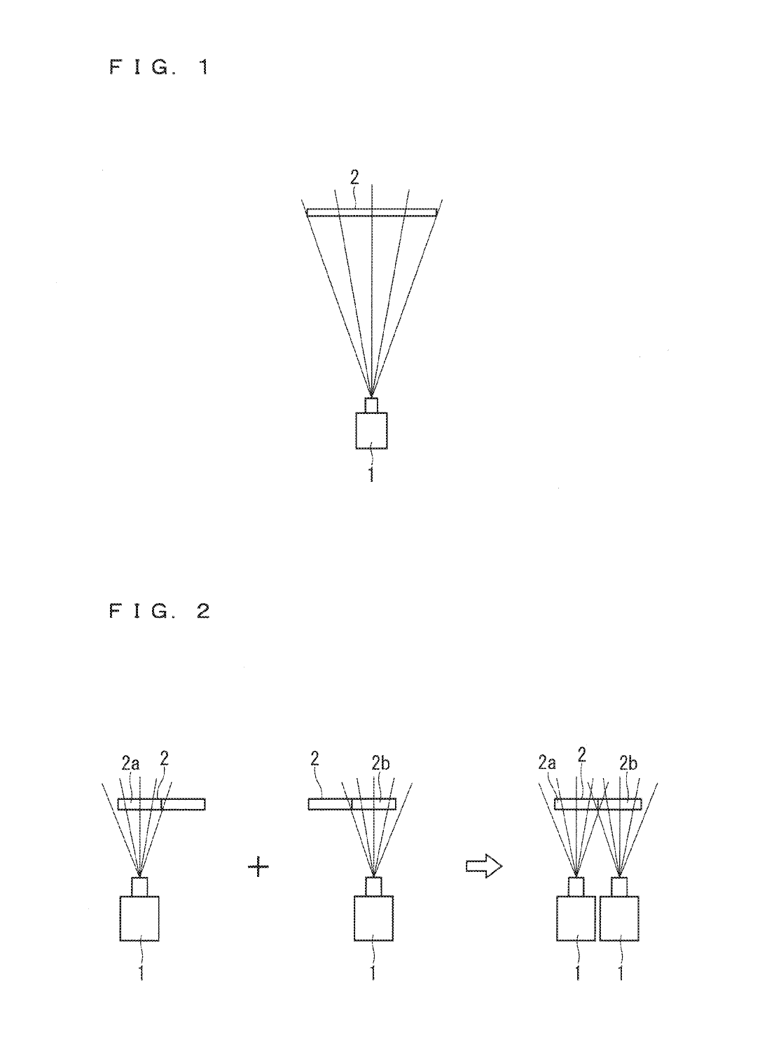

FIG. 1 illustrates an outline of uneven brightness measurement according to a first underlying technique. A brightness measuring device 1 is arranged to squarely face a measurement sample 2 and measures the brightness distribution in a display surface of the measurement sample 2 at a time. The brightness measuring device 1 is, for example, a 2D color analyzer for luminance measurement (CA-2000 from Konica Minolta Inc.) publicly known as an in-plane brightness measuring device. The measurement sample 2 is, for example, a 7-inch diagonal WVGA liquid crystal display.

In the method for measuring the brightness distribution in a display surface at a time, a relatively coarse resolution may be obtained in a measurement result if the measuring element of the brightness measuring device 1 has a resolution lower than the resolution of the measurement sample 2.

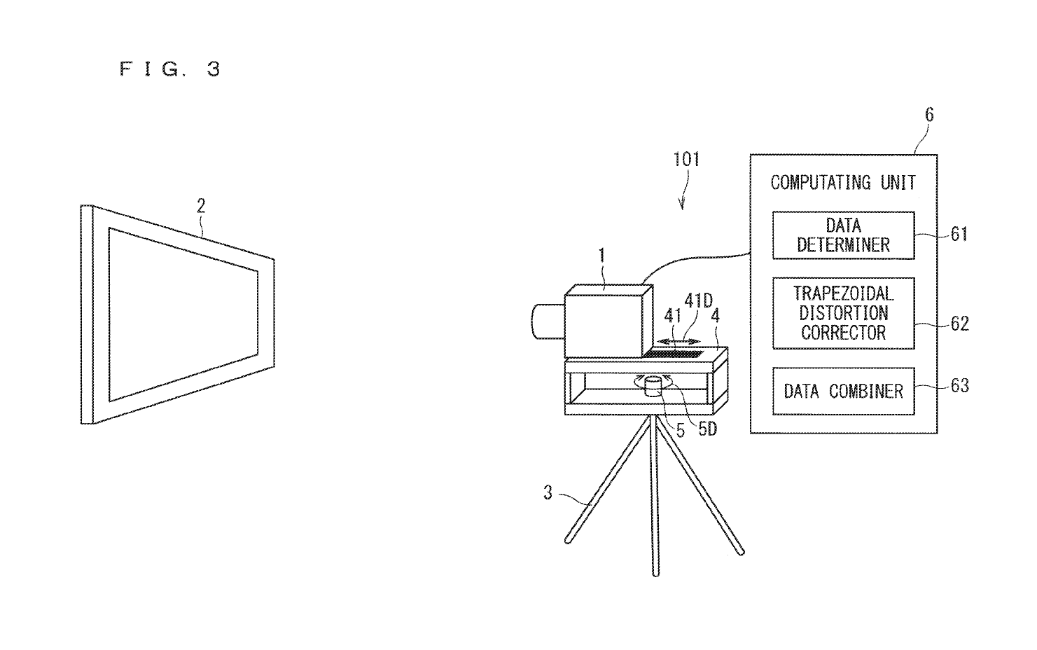

FIG. 2 illustrates an outline of uneven brightness measurement according to a second underlying technique. This method involves dividing a display surface of a measurement sample 2 into a plurality of areas, measuring a brightness distribution for every divided area, and then combining pieces of measurement data. In FIG. 2, the display area of the measurement sample 2 is divided into a left half and a right half respectively as a first display area 2 a and a second display area 2b.

In the measurement through division illustrated in FIG. 2, pieces of measurement data of the respective divided areas are combined for easy understanding of the whole picture of the brightness distribution in a display surface. However, the first display area 2a and the second display area 2b are misaligned in the direction of observation due to the setting of the brightness measuring device 1, resulting in no continuity between the measurement data of the first display area 2a and the measurement data of the second display area 2b. Consequently, while the pieces of measurement data of the central portions of the first display area 2a and the second display area 2b can be compared with the pieces of measurement data of their adjacent areas, the measurement data of the boundary portion between the first display area 2a and the second display area 2b cannot be compared with the pieces of measurement data of its adjacent areas.

The present invention therefore has devised a way to obtain high-definition measurement data of a high-resolution measurement sample with an existing uneven brightness measuring apparatus, which will be described below.

### B. First Preferred Embodiment

B-1. Configuration

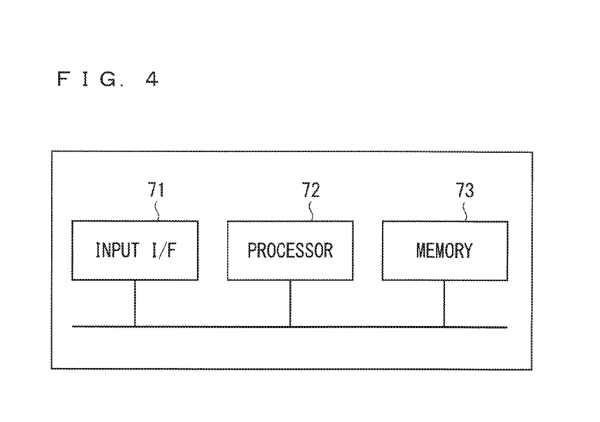

FIG. 3 is a view for explaining a configuration of an uneven brightness measuring apparatus 101 according to a first preferred embodiment of the present invention and a positional relationship between the uneven brightness measuring apparatus 101 and a measurement sample 2. In FIG. 3 and the following figures described in this specification, components similar to those of FIGS. 1 and 2 described in “A. Underlying Techniques” are denoted by' similar reference signs.

The uneven brightness measuring apparatus 101 includes a brightness measuring device 1, a jig 4, on which the brightness measuring device 1 is mounted, a tripod 3, on which the jig 4 is placed, and a computing unit 6.

Used as the brightness measuring device 1 is, for example, a 2D color analyzer for luminance measurement (CA-2000 from Konica Minolta Inc.) publicly known as an in-plane brightness measuring apparatus. The brightness measuring device 1 includes an objective lens and a CCD sensor (not shown) and measures the in-plane brightness or in-plane chromaticity of the measurement sample 2. The brightness measuring device 1 is equipped with a telephoto lens and has an angle of view of approximately ±4°, where the angle of view represents a measurement range of the telephoto lens.

Used as the measurement sample 2 is, for example, a 7-inch diagonal WVGA liquid crystal display. The measurement sample 2 is placed such that the direction normal to its display surface is horizontal and that the long sides of its display area are horizontal.

The uneven brightness measuring apparatus 101 is placed so as to squarely face the measurement sample 2 and observe the central portion of the display surface of the measurement sample 2 from the direction normal to the display surface.

The jig 4 has a rotation mechanism that rotates about a rotating, shaft 5 in the directions indicated by an arrow 5D. The brightness measuring device 1 can thus rotate about e rotating shaft 5 while being fixed to the jig 4.

The jig 4 has a slide mechanism 41 that slides the brightness measuring device 1 in the directions indicated by an arrow 41D. The brightness measuring device 1 can thus slide in the directions of the arrow 41D while being fixed to the jig 4. The directions of the arrow 41D are made parallel to the line normal to the display surface of the measurement sample 2, with the uneven brightness measuring apparatus 101 arranged to squarely face the measurement sample 2. The brightness measuring device 1 can thus be caused to slide by the slide mechanism 41 in parallel with the line normal to the display surface of the measurement sample 2.

The computing unit 6 includes a data determiner 61, a trapezoidal distortion corrector 62, and a data combiner 63. The data determiner 61 determines measurement data of each divided area from the measurement data of the brightness measuring device 1. The trapezoidal distortion corrector 62 corrects a trapezoidal distortion of the measurement data of the brightness measuring device 1. The data combiner 63 combines pieces of measurement data of the divided display areas of the measurement sample 2, which will be described below, thereby creating measurement data of an entire display surface of the measurement sample 2.

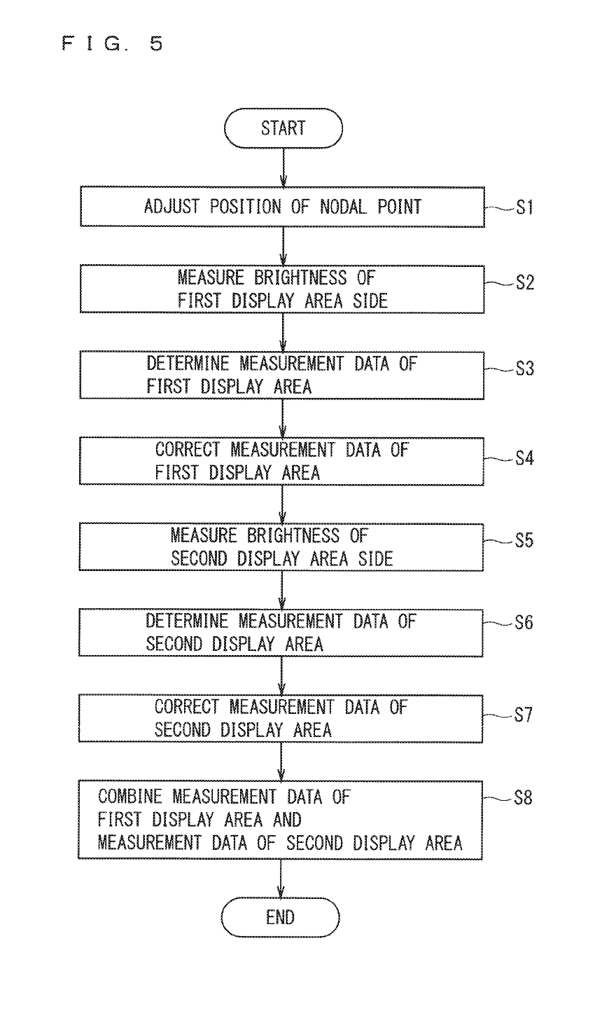

FIG. 4 illustrates a hardware configuration of the computing unit 6. The computing unit 6 is implemented by an input interface (I/F) 71, which obtains measurement data from the uneven brightness measuring apparatus I, a processor 72, and a memory 73. The data determiner 61, the trapezoidal distortion corrector 62, arid the data combiner 63 are implemented as functions of the processor 72 by the processor 72 such as a central processing unit (CPU) executing a software program stored in the memory 73 such as a random access memory (RAM). These units may be implemented by a plurality of processors 72 operating in cooperation with each other.

B-2. Measurement Procedure

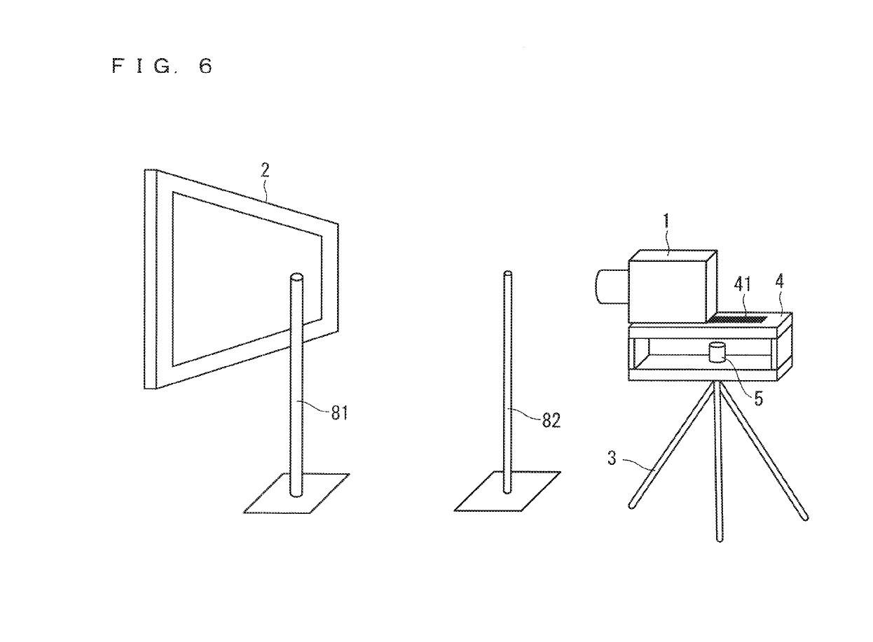

The procedure of measuring the in-plane brightness of the measurement sample 2 with the uneven brightness measuring apparatus 101 will be described with reference to the flowchart of FIG. 5.

First, the position of a nodal point of the brightness measuring device 1 is adjusted such that the nodal point coincides with the rotating shaft 5 of the jig 4 (step S1). The nodal point is the center of a focal point of an objective lens of the brightness measuring device 1.

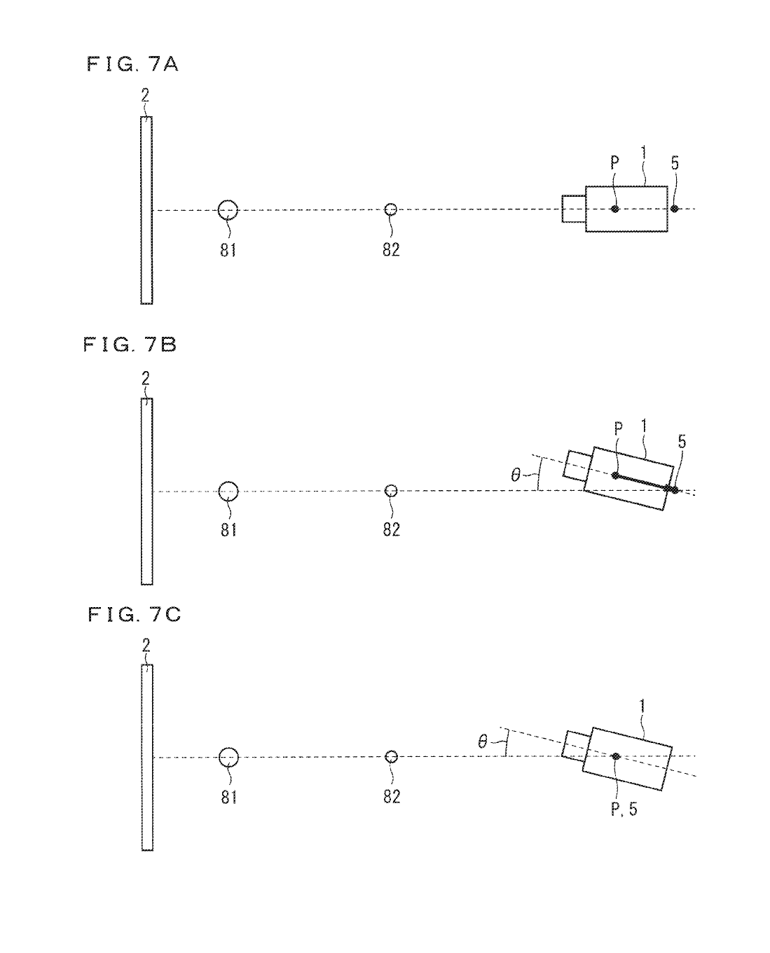

FIG. 6 is a perspective view for describing a method for aligning the nodal point of the, brightness measuring device 1. FIGS. 7A, 7B, and 7C are top views for explaining the method for aligning the nodal point of the brightness measuring device 1. Rods 81 and 82 are prepared as auxiliary parts for aligning the nodal point. The rods 81 and 82 are placed vertically on an optical axis of the brightness measuring device 1. In this case, the rods 81 and 82 are observed overlapping each other from the brightness measuring device 1 as illustrated in FIG. 7A. The nodal point is indicated by P in FIGS. 7A, 7B, and 7C.

Then, the brightness measuring device 1 is rotated by θ, for example, approximately 3° about the rotating shaft 5 (FIG. 7B). The nodal point P does not coincide with the rotating shaft 5, and thus, the rods 81 and 82 are observed not overlapping each other from the brightness measuring device 1 in this state.

Thus, the brightness reasuring device 1 is moved back and forth on the jig 4 by the slide mechanism 41 to find a position in the brightness measuring device 1 at which the rods 81 and 82 are observed overlapping each other from the brightness measuring device 1. When this positional adjustment causes the rods 81 and 82 to be observed overlapping each other, the nodal point P of the brightness measuring device 1 coincides with the rotating shaft 5 (FIG. 7C). Since the slide mechanism 41 is aimed at aligning the nodal point P of the brightness measuring device 1 with the rotating shaft 5 of the jig 4, it suffices that the jig 4 includes a mechanism that moves the brightness measuring device 1 relative to the rotating shaft 5 of the jig 4. For example, such a mechanism may be a moving mechanism such as a mechanism that adjusts a position stepwise, in addition to the slide mechanism 41. Causing the nodal point P of the brightness measuring device 1 to coincide with the rotating shaft 5 eliminates an effect of parallax on the pieces of measurement data of the display areas 2a and 2b, which will be described in a subsequent step, thus providing continuity to these pieces of data. As a result, these pieces of data can be combined to obtain measurement data of the entire display area.

Step S1 of FIG. 5 is performed as described above. Subsequently, after the alignment of the nodal point P, the brightness of the measurement sample 2 is measured. The display area of the measurement sample 2 is divided into a plurality of areas, and uneven brightness is measured for every divided area. Although description is given of the example in which the display area of the measurement sample 2 is divided into two areas, a first display area 2a in a left half and a second display area 2b in a right half, the display area can be divided in any other way. For example, the display area may be divided into three or four areas or may be divided vertically. The brightness measuring device 1 can measure higher-resolution measurement sample 2 by dividing a display area into more pieces. In this measurement, uneven brightness is measured during white display of the measurement sample 2. Alternatively, uneven brightness may be measured during gray or black display.

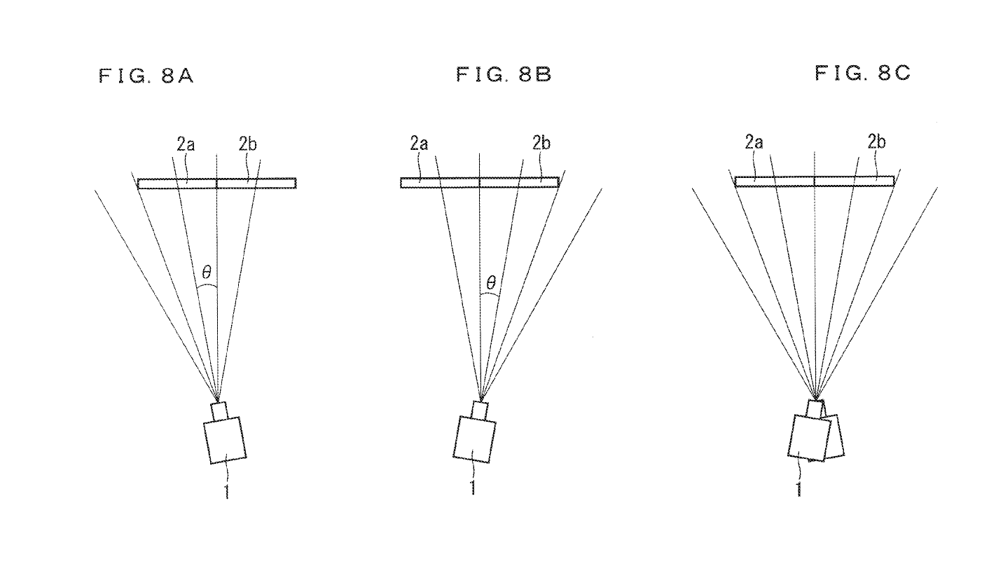

FIGS. 8A, 8B, and 8C are views for explaining a method for measuring the brightness of the measurement sample 2 by the brightness measuring device 1. First, the brightness measuring device 1 is rotated by the rotation mechanism of the jig 4 by 3° from the position in which the brightness measuring device 1 squarely faces the measurement sample 2, and measures the brightness distribution of the first display area 2a side (step S2). FIG. 8A illustrates the positional relationship between the measurement sample 2 and the brightness measuring device 1 in this state. Description is made as “the brightness distribution of the first display area 2a side” above because this step, not only the brightness distribution of the first display area 2a but also the brightness distribution of a partial area of the second display area 2b adjacent to the first display area 2a is measured.

Then, the data determiner 61 determines the measurement data (first measurement data) of the first display area 2a from the pieces of measurement data obtained in step S2 (step S3). A specific example of this determination method will be described below.

As illustrated in FIG. 8A, the brightness measuring device 1 obliquely measures the brightness of the first display area 2a side without squarely facing the first display area 2a. As illustrated in FIG, 9, thus, the measurers measurement data (first measurement data) of the first display area 2a is the measurement data of a trapezoidal area. That is to say, a trapezoidal distortion occurs in the measurement data. The trapezoidal distortion corrector 62 thus performs a computation of correcting the trapezoidal distortion (step S4). A specific example of this correction computation will be described below.

Then, the brightness measuring device 1 is rotated by the rotation mechanism of the jig 4 by −3° from the state in which the brightness measuring device 1 squarely faces the measurement sample 2, and measures the brightness distribution of the second display area 2b side (step S5). FIG. 8B illustrates a positional relationship between the measurement sample 2 and the brightness measuring device 1 in this state. Description is made as “the brightness distribution of the second display area 2b side” above because in this step, not only the brightness distribution of the second display area 2b but also the brightness distribution of a partial area of the first display area 2a adjacent to the second display area 2b is measured.

Then, the data determiner 61 determines the measurement data of the second display area 2 b from the pieces of measurement data obtained in step S5 (step S6). The determination method is similar to that of step S3, a specific example of which will be described below.

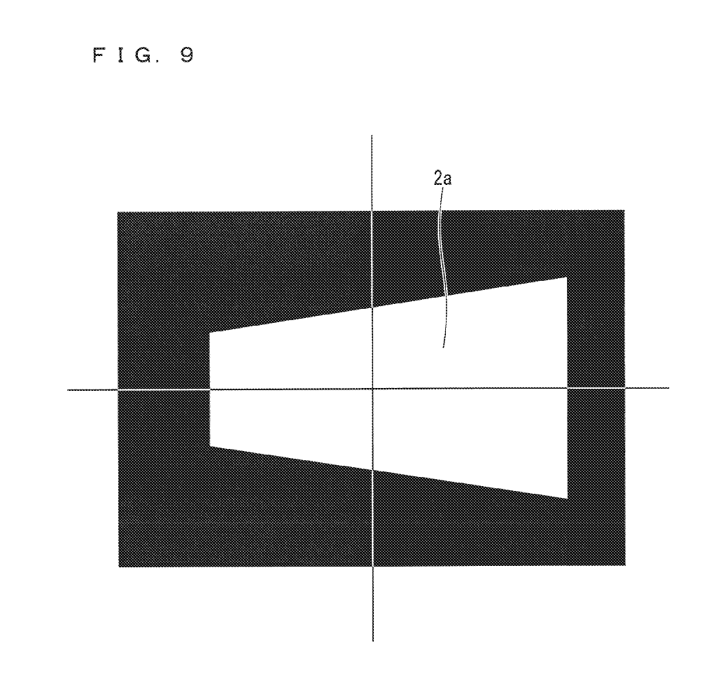

As illustrated in FIG. 8B, the brightness measuring device 1 obliquely measures time brightness of the second display area 2b sidewithout squarely facing the second display area 2b. Thus, a measurement result of the second display area 2b is also a trapezoidal shape, similarly to the measurement result of the first display area 2a illustrated in FIG. 9. Specifically, a trapezoidal shape obtained by horizontally mirroring the measurement result of the first display area 2a illustrated in FIG. 9 is obtained. The trapezoidal distortion corrector 62 thus also performs a computation of correcting the measurement result of the second display area 2b (step S7). This correction computation is similar to that of step S4, a specific example of which will be described below.

Finally, the data combiner 63 combines the measurement data of the first display area 2a, which has been corrected in step S4, and the measurement data of the second display area 2b, which has been corrected in step S7, thus obtaining measurement data on the brightness distribution of the entire display surface of the measurement sample 2 (step S8). A measurement value of a boundary portion between the first display area 2a and the second display area 2b is included in the measurement data of the first display area 2a as well as the measurement data of the second display area 2b. Both the pieces of measurement data have been measured by the brightness measuring device 1 rotating about the nodal point P in different rotational positions, and thus, the directions of the measurement point and the brightness measuring device 1 are identical in both the measurements. There is accordingly no effect of the viewing angle characteristics of the measurement sample 2, thus obtaining the same value for both the pieces of measurement data of the boundary portion between the first display area 2a and the second display area 2b.

Both the pieces of measurement data are combined such that the portions with the same value overlap each other with respect to the boundary portion between the first display area 2a and the second display area 2b, thus obtaining measurement data on the brightness distribution of the entire display surface of the measurement sample 2 (FIG. 8C).

The uneven brightness measuring apparatus 101 according to the first preferred embodiment includes the brightness measuring device 1, the jig 4, and the data combiner 63. The brightness measuring device 1 measures the in-plane brightness of the display surface of the measurement sample 2. The brightness measuring device 1 is mounted on the jig 4. The jig 4 includes the rotation mechanism that rotates the brightness measuring device 1 about the nodal point P of the brightness measuring device 1. The data combiner 63 combines the first measurement data of the first display area 2a in the display area, which is obtained by the brightness measuring device 1, and the second measurement data of the second display area 2b in the display area adjacent to the first display area 2a, which is obtained by the brightness measuring device 1. The first measurement data and the second measurement data, which are pieces of data obtained through the measurements by the brightness measuring device 1 rotated in different positions by the rotation mechanism, are continuous data free from parallax. Combining these pieces of data thus obtains the measurement data on the uneven brightness of the entire display surface of the measurement sample 2. This enables brightness measurement with high definition if the measurement sample 2 has a resolution higher than the resolution of the measurement element of the brightness measuring device 1.

B-3. Determination of Measurement Data

The method for determining measurement data in steps S3 and S6 of FIG. 5 will be described. To determine the measurement data of the first display area 2a from the measurement data of the first display area 2a side and determine the measurement data of the second display area 2b from the measurement data of the second display area 2b side, a boundary between the first display area 2a and the second display area 2b needs to be obtained.

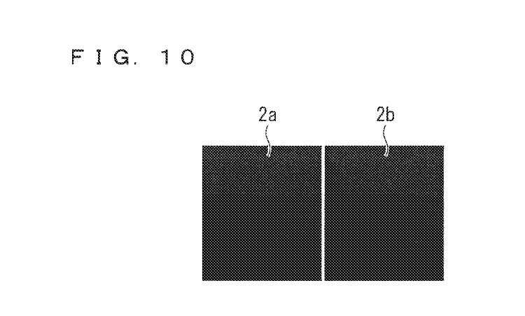

FIG. 10 illustrates an image displayed on the display surface of the measurement sample 2 to find the boundary. The image has a white line at a central portion of the display area, that is, at a boundary between the first display area 2a and the second display area 2b.

After measuring the brightness of the first display area 2a side, the brightness measuring device 1 measures the brightness of the image illustrated in FIG. 10 displayed on the measurement sample 2 while keeping its rotational position. This achieves, in the brightness data of 980×980 dots, linearly shaped data indicating high brightness corresponding, to the line at the central portion. The linearly shaped data is located at the central portion of the measurement sample 2, and thus, this data is used to determine the brightness data of the first display area 2a.

Similarly, after measuring the brightness of the second display area 2b side, the brightness measuring device 1 measures the brightness of the image illustrated in FIG. 10 displayed on the measurement sample 2 while keeping its rotational position, and determines the brightness data of the second display area 2b.

However, the method for identifying a boundary of a display area is not limited to the method above. In one example method, the boundary of a display area may be calculated from, for example, the rotation angle of the brightness measuring device 1 in the brightness measurements of the first display area 2a and the second display area 2b, the distance between the brightness measuring device 1 and the measurement sample 2, and the lens performance of the brightness measuring device 1.

B-4. Correction of Measurement Data

Description will now be given of the correction of a trapezoidal distortion of the measurement data of the second display area 2b. The correction of a trapezoidal distortion of the measurement data of the first display area 2a is similar to the correction of a trapezoidal distortion of the measurement data of the second display area 2b, and thus, only the correction of a trapezoidal distortion of the measurement data of the second display area 2b will be described here.

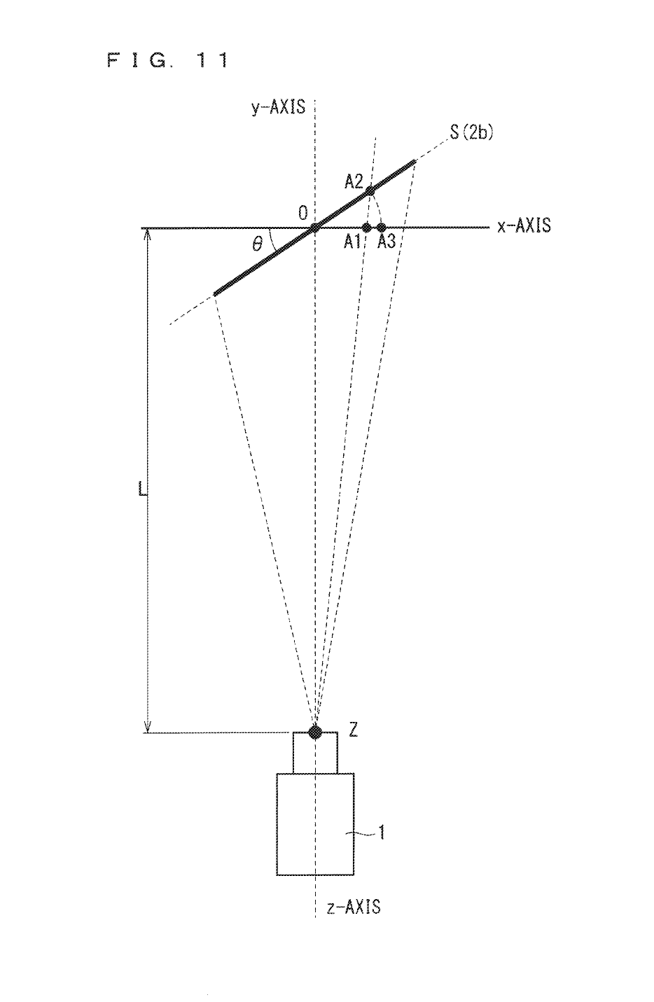

FIG. 11 illustrates a positional relationship between the second display area 2b and the brightness measuring device 1 in the brightness measurement of the second display area 2b (represented by a plane S herein). The brightness measuring device 1 tilts by an angle θ from the direction in which the brightness measuring device 1 squarely faces the second display area 2b of the measurement sample 2 and then measures the brightness of the second display area 2b. The brightness distribution within an imaging range is projected onto an xy plane squarely facing the brightness measuring device 1, so that the measurement data is recorded. When the origin points of an x-axis and a y-axis are set at the positions facing the brightness measuring device 1 and a z-axis is set to be perpendicular to the xy plane, the brightness measuring device 1 is positioned at a point Z (0, 0, L) on the z-axis. The brightness value of a measurement point A1 (p, q, 0) is t brightness value of a point A2 on the measurement sample 2. Now, the coordinates of the point A2 are obtained.

The measurement sample 2 is actually present on the plane S represented by an expression below.

x·sin θ+z·cos θ=0

Therefore, the point A2 can be computed as an intersection of the plane S and a straight line AZ, and the coordinates of the point A2 (x2, y2, z2) are as follows.

$$x = p \cdot \frac{L cos θ}{L cos θ - p sin θ}$$

$$y = q \cdot \frac{L cos θ}{L cos θ - p sin θ}$$

$$z = L ( 1 - \frac{L cos θ}{L cos θ - p sin θ} )$$

An appropriate point A2 can be moved to be located on the XY plane through rotation about the Y axis by −θ. When the point A2 after being moved is a point A3 (x3, y3, z3), it is as follows.

$$rotation matrix = [ \begin{matrix}cos θ & 0 & - sin θ \\ 0 & 1 & 0 \\ sin θ & 0 & cos θ\end{matrix} ]$$

$$x = p \cdot \frac{L {cos}^{2} θ}{L cos θ - p sin θ} - L ( 1 - \frac{L cos θ}{L cos θ sin θ - p {sin}^{2} θ} )$$

$$y = q \cdot \frac{L cos θ}{L cos θ - p sin θ}$$

$$z = 0$$

The brightness value of an appropriate point A1 in the measurement data is actually the brightness value of the point A2 on the measurement sample 2, Replacing this brightness value with the brightness value of the point A3 on the xy plane enables the correction of a trapezoidal distortion.

The value of a required location is subjected to, for example, linear interpolation computation on the basis of the pieces of measurement data of the respective points calculated above, thus obtaining measurement data of an appropriate point. This completes the correction computation. The correction computation described above is merely an example, and any other correction method may be used.

The uneven brightness measuring apparatus 101 includes the trapezoidal distortion corrector 62 that corrects a trapezoidal distortion of the measurement data, which occurs as a result of the brightness measuring device 1 not squarely facing a measurement area, arid therefore can obtain accurate measurement data whose trapezoidal distortion has been corrected.

### C. Second Preferred Embodiment

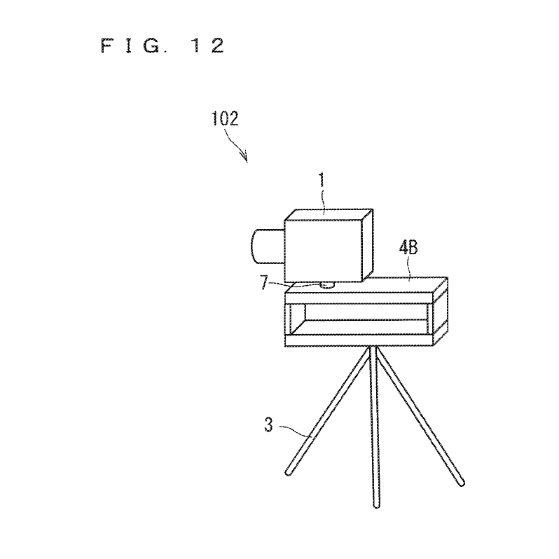

FIG. 12 illustrates the configuration of an uneven brightness measuring apparatus 102 according to a second preferred embodiment. The uneven brightness measuring apparatus 102 includes a computing unit 6 as in the first preferred embodiment, which is not illustrated in FIG. 12. The uneven brightness measuring apparatus 102 includes a tripod 3, a jig 4B, which is fixed to the tripod 3, a brightness measuring device 1, which is mounted on the jig 4B, and a computing unit 6 (not shown).

The brightness measuring device 1 is mounted on the jig 413 with a screw 7. The brightness measuring device 1 is rotatable about the screw 7 serving as a rotating shaft. In other words, the jig 4 B includes a rotation mechanism that rotates the brightness measuring device 1 about the screw 7 serving as a rotating shaft. The position in the brightness measuring device 1 at which the screw is mounted is set in advance such that the rotating shaft of the screw 7 coincides with the nodal point P of the brightness measuring device 1, thus eliminating the step of aligning the nodal point P illustrated in step S1 of FIG. 5. The jig 4B does not require a slide mechanism 41 for the alignment.

In the uneven brightness measuring apparatus 102, a distance between the brightness measuring device 1 and the rotating shaft of the rotation mechanism is fixed, and the distance cannot be adjusted. However, the rotating shaft of the rotation mechanism is preset to overlap the nodal point of the brightness measuring device 1, thus omitting the alignment of the nodal point.

The rotating shaft is caused to serve as the rotating shaft of the screw 7 for mounting the brightness measuring device 1 on the jig 4B, that is, the rotating shaft of the screw 7 is caused to overlap the nodal point of the brightness measuring device 1, thus eliminating the need for providing an additional rotation mechanism in the jig 4 B, which simplifies the configuration of the jig 4B.

D. Modifications

The description has been given assuming that the brightness measuring device 1 itself includes no rotation mechanism and is mounted on the jig 4B to rotate integrally with the jig 4B. Alternatively, the brightness measuring device 1 itself may include a rotation mechanism. The rotating shaft of the rotation mechanism is set to overlap the nodal point of the brightness measuring device 1. In other words, the brightness measuring device 1 includes a rotation mechanism that rotates the brightness measuring device 1 about the nodal point of the brightness measuring device 1. In this case, the jig 4B is not required.

In the description above, the data determiner 61, the trapezoidal distortion corrector 62, and the data combiner 63 are implemented by the processor 72 of FIG. 4 operating in accordance with the software program stored in the memory 73. Alternatively, the data determiner 61, the trapezoidal distortion corrector 62, and the data combiner 63 may be implemented by a signal processing circuit that implements this operation by an electric circuit that is hardware. In place of the term “unit”, the term “processing circuit” can be used to express the concept in which the data determiner 61, the trapezoidal distortion corrector 62, and the data combiner 63, which are software, are combined with the data determiner 61, the trapezoidal distortion corrector 62, and the data combiner 63, which are hardware.

While the invention has been shown and described in detail, the foregoing description is in all aspects illustrative and not restrictive. It is therefore understood that numerous modifications and variations can be devised without departing from the scope of the invention.

What is claimed is:

1. An uneven brightness measuring apparatus comprising:
a brightness measuring device to measure an in-plane brightness of a display surface of a measurement sample;
a jig on which said brightness measuring device is mounted, said jig including a rotation mechanism to rotate said brightness measuring device about a nodal point of said brightness measuring device; and
a data combiner to combine first measurement data of a first display area in said display surface and second measurement data of a second display area in said display surface adjacent to said first display area, said first measurement data and said second measurement data being obtained by said brightness measuring device,
wherein said first measurement data and said second measurement data are pieces of data obtained through measurements by said brightness measuring device rotated in different positions by said rotation mechanism.

2. The uneven brightness measuring apparatus according to claim 1, wherein said jig includes a moving mechanism to move said brightness measuring device such that the nodal point of said brightness measuring device coincides with a rotating shaft of said rotation mechanism.

3. The uneven brightness measuring apparatus according to claim 1, wherein
a distance between said brightness measuring device and a rotating shaft of said rotation mechanism is fixed, and
said rotating shaft of said rotation mechanism overlaps the nodal point of said brightness measuring device.

4. The uneven brightness measuring apparatus according to claim 3, wherein
said brightness measuring device is mounted on said jig with a screw, and
a rotating shaft of said screw overlaps the nodal point of said brightness measuring device.

5. An uneven brightness measuring apparatus comprising:
a brightness measuring device to measure an in-plane brightness of a display surface of a measurement sample; and
a data combiner to combine first measurement data of a first display area in said display surface and second measurement data of a second display area in said display surface adjacent to said first display area, said first measurement data and said second measurement data being obtained by said brightness measuring device,
wherein said brightness measuring device includes a rotation mechanism to rotate said brightness measuring device about a nodal point of said brightness measuring device, and
wherein said first measurement data and said second measurement data are pieces of data obtained through measurements by said brightness measuring device rotated in different positions by said rotation mechanism.

6. The uneven brightness measuring apparatus according to claim 1, further comprising
a trapezoidal distortion corrector to correct a trapezoidal distortion of measurement data generated as a result of said brightness measuring device not squarely facing a measurement area,
wherein said data combiner combines said first measurement data and said second measurement data that have been corrected by said trapezoidal distortion corrector.

7. The uneven brightness measuring apparatus according to claim 5, further comprising
a trapezoidal distortion corrector to correct a trapezoidal distortion of measurement data generated as a result of said brightness measuring device not facing measurement area,
wherein said data combiner combines said first measurement data and said second measurement data that have been corrected by said trapezoidal distortion corrector.
